(19) United States
(12) Patent Application Publication
(10) Pub. No.: US 2005/0141349 A1
(43) Pub. Date: Jun. 30, 2005

(54) Optical disk player

(75) Inventor: Frank Tso, Taipei (TW)

Correspondence Address: BACON & THOMAS, PLLC, 625 SLATERS LANE, FOURTH FLOOR, ALEXANDRIA, VA, 22314, US

(73) Assignee: Penbex Data Systems, Inc., Taipei (TW)

(21) Appl. No.: 10/836,187

(22) Filed: May 3, 2004

(30) Foreign Application Priority Data
Dec. 31, 2003 (TW) 092222999

(51) Int. Cl. H04B 1/20

(52) U.S. Cl. 369/12

(57) ABSTRACT

A portable optical disk player utilizes an optical disk to provide a language-learning function. The optical disk player comprises a processor, an optical disk reading device, a screen, a keyboard and an audio output device. The screen is mounted on the front surface of the portable optical disk player, whereas the cover for accessing the optical disk is mounted on the rear surface of the portable optical disk player. For the purpose of learning a language, a user can input commands or data to the processor, and then textual or image information is displayed on the screen. Audio information can be output through an audio output device.

### BACKGROUND OF THE INVENTION

1. Field of the Invention

The present invention relates to a portable optical disk device, and more particularly, to a portable optical disk player with a language-learning function.

2. Description of the Related Art

Several different types of optical disk players exist, such as desktop optical disk players, computer optical disk players and portable optical disk players. Portable optical disk players are typically CD players, which have small sizes that are easy to carry, and which have therefore become very popular electronic products.

The prior art portable optical disk player is used mainly for playing an optical disk that stores music and image data, and does not process optical disks that contain text files. Furthermore, the prior art portable optical disk player usually does not have a screen, or has only a small screen for simply displaying a play list. Therefore, the prior art portable optical disk player is not useful for language learning programs, since it can only support auditory learning, cannot display an article or image data, and cannot execute an interactive learning program to help a user to train his or her writing, reading, listening and speaking abilities.

Therefore, it is desirable to provide a portable optical disk player with a large display screen to mitigate and/or obviate the aforementioned problems.

### SUMMARY OF THE INVENTION

A primary objective of the present invention is to provide a portable optical device with a thin and large display screen at a low cost.

Another primary objective of the present invention is to provide a portable optical device with a complete input capability for executing various complicated language-learning programs.

In order to achieve the above-mentioned objectives of the present invention, a portable optical disk device comprises not only an optical disk reading device and an audio output device, but also a screen and a character inputting device on its front surface, and a cover on its back surface.

The cover is mounted on the back surface of the optical disk player, which is not the case in the prior art optical disk player. Since the cover is mounted on the back surface, rather than on the front surface of the optical disk player, a thickness of the cover can be reduced to a minimum to reduce a total thickness of the optical disk player. Furthermore, the mechanical design of the cover, the screen and the internal electronics are relatively simple so that manufacturing costs can be reduced.

When the optical disk player plays a language learning CD, the screen displays textual or image data from the CD; the output device plays audio data from the CD; the input device can input a command or character for learning purposes. According to different embodiments, the input device can be a keyboard or a stylus.

Other objects, advantages, and novel features of the invention will become more apparent from the following detailed description when taken in conjunction with the accompanying drawings.

### BRIEF DESCRIPTION OF THE DRAWINGS

FIG. 1 is a circuit diagram of an optical disk player according to the present invention.

FIG. 2 is a perspective drawing of a first embodiment according to the present invention, which shows a front surface of the optical disk player.

FIG. 3 is a perspective drawing of a first embodiment according to the present invention, which shows a back surface of the optical disk player.

FIG. 4 is a perspective drawing of a first embodiment according to the present invention, which shows a cover of the optical disk player when open.

FIG. 5 is a perspective drawing of a second embodiment according to the present invention, which shows a front surface of the optical disk player.

FIG. 6 is a perspective drawing of a third embodiment according to the present invention, which shows a front surface of the optical disk player.

### DETAILED DESCRIPTION OF THE PREFERRED EMBODIMENT

Three embodiments are provided in the following description.

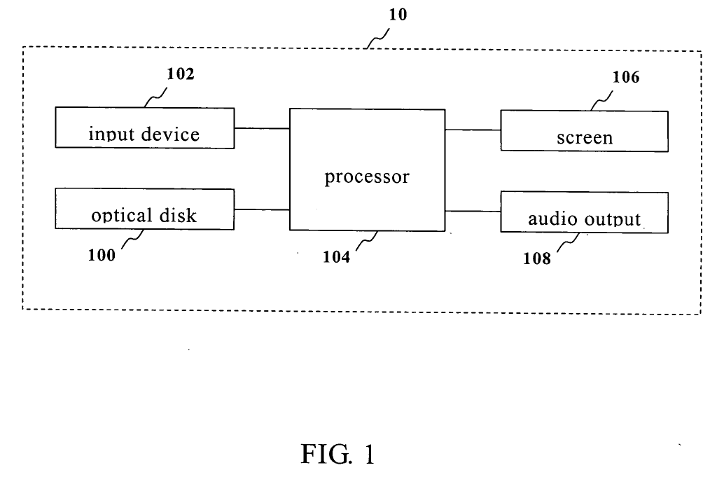

Please refer to FIG. 1. FIG. 1 is a circuit diagram of an optical disk player according to the present invention. As shown in FIG. 1, an optical disk player 10 comprises an optical disk reading device 100, an input device 102, a processor 104, a screen 106 and an audio output device 108. The processor 1.04 and the other devices (such as the optical disk reading device 100 and the input device 102) are all electrically connected together, so the processor 104 can control all of these devices. The optical disk reading device 100 reads a program or data stored on a CD, and then the processor 104 processes the program or data, and uses the screen 106 to display textual and image data, as well as using the audio output device 108 to play audio data. Furthermore, a user can use the input device 102 to input a command or character to launch other functions of the CD, which is a well-known technology and so will not be described here in any more detail.

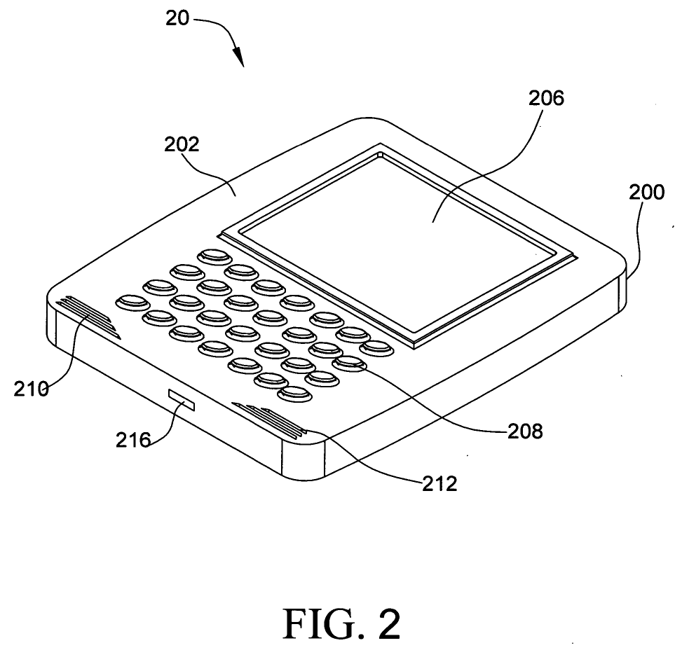

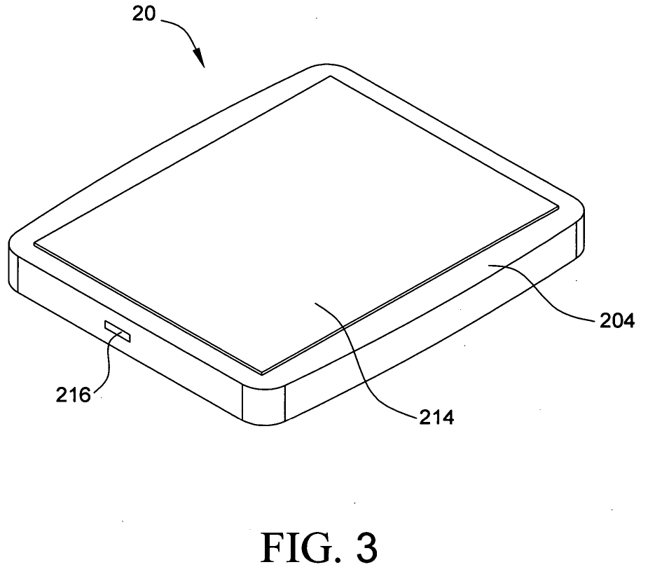

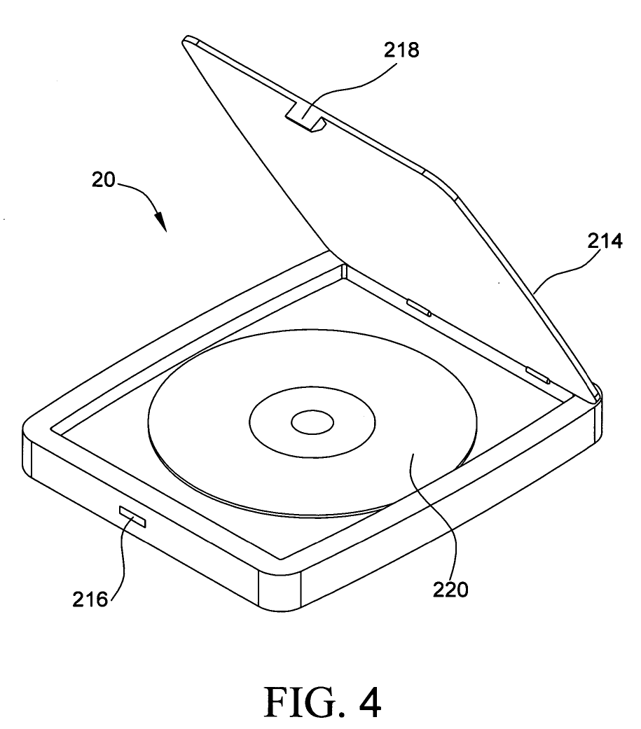

Please refer to FIG. 2 to FIG. 4. FIG. 2 is a perspective drawing of a first embodiment according to the present invention, which shows a front surface of an optical disk player 20. FIG. 3 is a perspective drawing of the first embodiment according to the present invention, which shows a back surface of the optical disk player 20. FIG. 4 is a perspective drawing of the first embodiment according to the present invention, which shows a cover of the optical disk player 20 when open. The portable optical disk player 20 has a housing 200; the housing 200 has a front surface 202 and a back surface 204. An optical disk reading device 220 is mounted within the housing 200; a screen 206, a keyboard (i.e. input device) 208 and a set of audio output jacks 210, 212 are disposed on the front surface 202. A cover 214 is mounted on the back surface 204. Two latches 216, 218.of the cover 214 are separately disposed on the housing 200 and the cover 214.

The screen 206 is used for displaying textual or image data, and is preferably a thin display screen, such as a TFT-LCD. A primary characteristic of the present invention is the use of a large display screen, as depicted by the screen 206, which is completely different from the small screens used in the prior art for displaying a play list. The area of the screen may range from 9 cm² to 250 cm². Another primary characteristic of the present invention is that the cover 214 of the present invention is mounted on the back surface 204 of the portable optical disk player 20, and not on the front surface 202 like the screen 206. The reason for this is that, if the cover 214 were mounted on the front surface 202, the screen 206 would need to be mounted on the cover 214; however, the cover 214 is a lift-open mechanism. The wire connection design between the screen 206 and the processor 104 is typically quite complicated (often requiring bus wires). In addition, if the screen 206 were mounted on the front surface 214, and to simplify the manufacturing process the optical disk reading device 220 were mounted on the same side with the screen 206, the thickness and the weight of the cover 214 would be increased. In the present invention, the cover 214 is mounted on the back surface 204 of the portable optical disk player 20, and the cover 214 does not comprise any other important electronic elements. Therefore, the screen 206, the keyboard 208, the optical disk reading device 220 and the processor 104 are all mounted on the same side with the front surface 214, which simplifies the manufacturing process and reduces the thickness of the portable optical disk player.

The keyboard of the first embodiment is used to enable a user to input commands or data to launch different language learning functions contained on the CD. The keyboard 208 can have 26 English language character keys, 10 numeric keys or a plurality of function keys.

The cover 214 of this embodiment has a very simple design; a latch 216 is placed on the housing 200, and a slot 218 is correspondingly placed on the cover 218 for accepting the latch 216. The cover 214 can be closed or opened by way of the latch 216 and the slot 218. The user moves the CD from, or into, the optical disk reading device 220 by opening the cover 214. Since the cover 214 is mounted on the back surface 204 of the portable optical disk player 20, and not the front surface 202, the thickness of the cover 214 can be reduced to a minimum to reduce the thickness of the portable optical disk player 20.

The optical disk reading device 220 may be a CD-ROM drive, a CD-RW drive, a DVD-ROM drive or a DVD-RW drive.

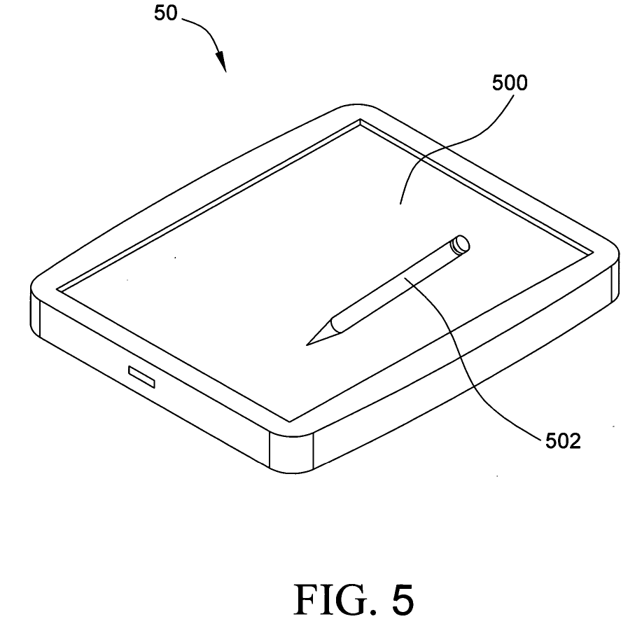

Please refer to FIG. 5. FIG. 5 is a perspective drawing of a second embodiment 50 according to the present invention, which shows a front surface of the optical disk player. A main difference between the second embodiment 50 and the first embodiment 20 is that the portable optical disk player 50 employs a touch screen 500 as the screen, and a stylus 504 as the input device to input commands or data through the touch screen 500 to launch different language learning functions on the CD. The user can input English characters, numbers, or utilize a software keyboard to input data with the stylus or a finger. The portable optical disk player 50 further comprises a receptacle (not shown) for holding the stylus 504.

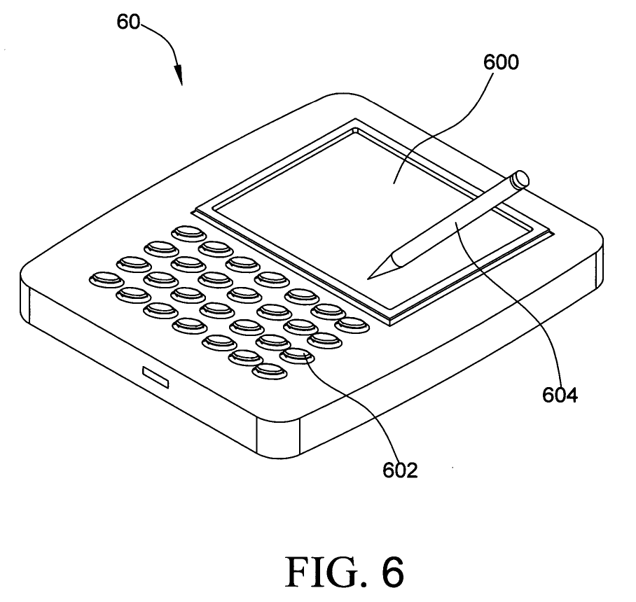

Please refer to FIG. 6. FIG. 6 is a perspective drawing of a third embodiment 60 according to the present invention, which shows a front surface of the optical disk player 60. The third embodiment 60 basically combines features of the first embodiment 20 and the second embodiment 50, comprising a keyboard 602, a touch screen 600 and a stylus 604.

Although the present invention has been explained in relation to its preferred embodiment, it is to be understood that many other possible modifications and variations can be made without departing from the spirit and scope of the invention as hereinafter claimed.

1. A portable optical disk player, capable of utilizing an optical disk containing textual and audio data to provide a language-learning function, the optical disk player comprising:
a housing including a front surface and a back surface;
a cover mounted on the back surface for covering the optical disk;
a processor mounted in the housing;
an optical disk reading device mounted in the housing and electrically connected to the processor for reading data stored on the optical disk;
a screen mounted on the front surface of the housing and electrically connected to the processor for displaying the textual data;
an audio output device electrically connected to the processor for outputting audio data; and
an input device mounted on the front surface of the housing and electrically connected to the processor for inputting character data.

2. The optical disk device as claimed in claim 1, wherein the optical disk reading device is a CD-ROM drive, a CD-RW drive, a DVD-ROM drive or a DVD-RW drive.

3. The optical disk device as claimed in claim 1, wherein the screen is a TFT-LCD.

4. The optical disk device as claimed in claim 1, wherein the output device comprises a keyboard.

5. The optical disk device as claimed in claim 4, wherein the keyboard comprises a plurality of function keys.

6. The optical disk device as claimed in claim 4, wherein the keyboard comprises 26 English language character keys.

7. The optical disk device as claimed in claim 4, wherein the keyboard comprises 10 numeric keys.

8. The optical disk device as claimed in claim 1, wherein the input device further comprises a stylus, and the screen is a touch screen.

9. The optical disk device as claimed in claim 1, wherein an area of the screen is between 9 cm² and 250 cm².
